(19) United States
(12) Patent Application Publication
(10) Pub. No.: US 2026/0087689 A1
(43) Pub. Date: Mar. 26, 2026

(54) INTERACTIVE DIFFUSION-BASED TEXTURE EDITING

(71) Applicant: Adobe Inc., San Jose, CA (US)

(72) Inventors: Julia Guerrero Viu, Zaragoza (ES); Valentin Deschaintre, London (GB); Yiwei Hu, San Jose, CA (US); Paul Guerrero, London (GB); Milos Hasan, San Jose, CA (US); Arthur Roullier, Paris (FR); Ajinkya Kale, San Jose, CA (US); Midhun Harikumar, Santa Clara, CA (US)

(21) Appl. No.: 18/894,807

(22) Filed: Sep. 24, 2024

(51) Int. Cl. G06T 11/00; G06F 40/40; G06T 11/60

(52) U.S. Cl. CPC G06T 11/10; G06F 40/40; G06T 11/60

(57) ABSTRACT

Certain aspects and features of the present disclosure relate to providing interactive diffusion-based texture editing. For example, one or more textual prompts corresponding to an appearance of a texture can be provided. For example, a method involves accessing a texture image and a textual prompt corresponding to the texture image. The method further involves computing, using an image-conditioned diffusion model, image embeddings corresponding to the textual prompt. The method also involves defining, using the image embeddings, a varying appearance of the texture image. The varying appearance corresponds to the textual prompt. The method additionally involves presenting the varying appearance of the texture image for display in an interactive texture editing element.

### TECHNICAL FIELD

The present disclosure generally relates to production and/or editing of graphical textures for use within graphical design software for, as examples, animation, video games, visual effects, or material design. More specifically, but not by way of limitation, the present disclosure relates to programmatic techniques to interactively edit textures by applying an editing attribute to a desired, varying degree based on natural language textual prompts in order to create different appearances while maintaining the identity of the texture being edited.

### BACKGROUND

Graphics design and similar software applications are used for a number of different functions connected to manipulating or editing digital images. Textures are ubiquitous in such image manipulation. For example, such software applications may be used to create and render images including objects with realistic surface textures based either on photographs or graphically designed imagery. As examples, a brick wall may appear as brick texture, and a wooden surface of a table may appear as wood texture. Such textures may be represented mathematically for storage and digital processing, and can be manipulated by a designer with significant artistic and technical skill while controlling the many parameters involved using a graphical design software application.

### SUMMARY

Certain aspects and features of the present disclosure relate to providing interactive diffusion-based texture editing, according to certain embodiments. For example, a method involves accessing a texture image and a textual prompt corresponding to the texture image. The method further involves computing, using an image-conditioned diffusion model, image embeddings corresponding to the textual prompt. The method also involves defining, using the image embeddings, a varying appearance of the texture image, the varying appearance corresponding to the textual prompt. The method additionally involves presenting the varying appearance of the texture image for display in an interactive texture editing element.

Other embodiments of this aspect include corresponding computer systems, apparatus, and computer programs recorded on one or more computer storage devices, each configured to perform the actions of the methods.

This summary is not intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim.

### BRIEF DESCRIPTION OF THE DRAWINGS

Features, embodiments, and advantages of the present disclosure are better understood when the following Detailed Description is read with reference to the accompanying drawings, where:

FIG. 1 is a diagram showing an example of a computing environment for providing interactive diffusion-based texture editing, according to certain embodiments.

FIG. 2 is a diagram of an example of interactively changing a texture image using an interactive texture editing element, according to certain embodiments.

FIG. 3 is a flowchart of an example of a process for providing interactive diffusion-based texture editing, according to some embodiments.

FIG. 4 is an example representation of converting text embeddings to image embeddings as part of providing interactive diffusion-based texture editing, according to certain embodiments.

FIG. 5 is an example graphical representation of computing a direction between prompts that define an edited attribute as part of providing interactive diffusion-based texture editing, according to certain embodiments.

FIG. 6 is a flowchart of another example of a process for providing interactive diffusion-based texture editing, according to some embodiments.

FIG. 7 is a diagram of an example of a computing system that can provide interactive diffusion-based texture editing, according to some embodiments.

### DETAILED DESCRIPTION

Realistic-looking textures can be an important component in graphical design. A graphical design application may be used to create and render images including objects with realistic surface textures, which in real life would vary according to lighting, environmental conditions, nature, or other factors. Graphics designers need to control the appearance of a texture to simulate various real-life conditions.

Texture editing is a long-standing challenge in computer graphics. One way to achieve a desired effect is to painstakingly manipulate many individual elements of a texture image in order to achieve the desired result. Such a process is exceedingly time consuming and requires significant skill and determination. Recently, deep learning approaches have been used for synthesis of larger versions of input textures. One approach uses procedural modeling, where the textures are defined as a combination of noise, patterns, and filter functions. Each of the many functions is defined by a set of parameters, which can be manipulated by artists using controls presented in a user interface. However, textures created in this manner are challenging to author, requiring significant artistic and technical skill, because the parameters do not always correspond to intuitive concepts. Further, the interactions between the various parameters may be exceedingly complex to understand, resulting in a time-consuming process based partly on trial and error.

Some existing non-textural graphical editing techniques simplify editing by providing for the use of natural language prompts. However, these techniques depend on cross-attention maps. Cross-attention maps can work for non-texture images that have a clear structure with individual objects that correspond to phrases of the text prompt. Textures often lack such a clear separation into individual objects and cross-attention maps therefore are unable to map a textual prompt and fail to properly represent texture identity.

As described above, existing texture editing techniques are cumbersome, time consuming, and/or require significant training and skill to execute. Existing graphical editing techniques that rely on natural language prompts do not work well for texture editing, since they require structure that is lacking in textures.

Embodiments described herein address the above issues by using texture manipulations in the embedding space. These intuitive manipulations can be based on “directions” for textures, each of which defines the chosen extent of a perceived property such as weathering, scale, roughness, and more. The approach allows interactive elements such as sliders to be quickly displayed for custom concepts based on direct prompts. The editing directions are intuitive to define and texture identity can be preserved through editing. Ground-truth annotated data is not needed. To make the editing direction easy for a graphical designer to define, understandable textual prompts can be used, e.g., “aged wood” to “new wood.”

In some examples, a graphical design application causes the processor to compute possible image embeddings for each of two text prompts using a texture prior network, resulting two clusters of embeddings, one for each prompt. A direction between the two cluster centers can then be computed, while averaging over multiple image embeddings to filter out texture identity from the chosen editing attribute. Dimensions do not contribute to the attribute that is being edited, but rather contain noise that results in identity variations can be empirically determined and removed.

For example, a graphical design application is loaded with an image of a texture and provided with one or more textual prompts. As examples, the texture image my be obtained from a preexisting photograph or a graphical design. Textual prompts may be provided by a user of the graphical design application, for example, by typing the textual prompts into a menu or by responding to a prompt generated by the graphical design application. The graphical design application can use a processor to compute image embeddings over an image-conditioned diffusion model for the textual prompts. As an example, the image embeddings may be computed using a texture prior network. The image embeddings can be used to produce clusters of embeddings. The graphical design application can determine an initial editing direction between statistical centers of the clusters of embeddings and select a subset of dimensions from the initial editing direction. The subset can be selected based on an intra-cluster distance and an inter-cluster distance to produce an edited attribute traversable between the original appearance and the target appearance of the texture image while maintaining texture identity.

The graphical design application can present the varying appearance of the texture image for display in an interactive texture editing element. For example, this texture editing element may be displayed on an output device. The editing element may include the varying appearance with a displayed slider that responds to being manipulated using a mouse or a pointing device. At one end of the slider's travel, the original appearance of the texture image is displayed. At the other end of the slider's travel, a target appearance of the texture image is displayed, and a degree of change corresponds to the position of the slider. Once the user achieves the desired texture appearance, the texture image with that appearance can be stored for future use or copied into a graphical design.

In some examples, the texture prior network includes a domain diffusion prior model trained for a texture domain. The domain diffusion prior model may be trained to generate visual language model (VLM) image embeddings given a VLM text embedding. The image-conditioned diffusion model can be trained with a dataset of text-free images, and a subset of the text-free images can be classified as textures. The domain diffusion prior model can be trained using the subset of the text-free images.

In some examples, the graphical design application can accept one or more additional textual prompts and compute one or more additional edited attributes based on the additional textual prompts. Textures with the attributes applied at the same time to independently varying degrees can be displayed simultaneously.

The manipulation of a diffusion model trained on image embeddings as opposed to text embeddings provides for the texture identity to be preserved through the editing process. Thus, rusted metal does not begin to look like weathered wood, stones do not begin to look like leaves, etc. The use of a texture diffusion prior network allows the attribute to be edited to be defined intuitively and quickly with textual prompts, speeding up workflow and providing real-time visual feedback to a graphical designer making use of a graphical design application incorporating the described texture editing capability.

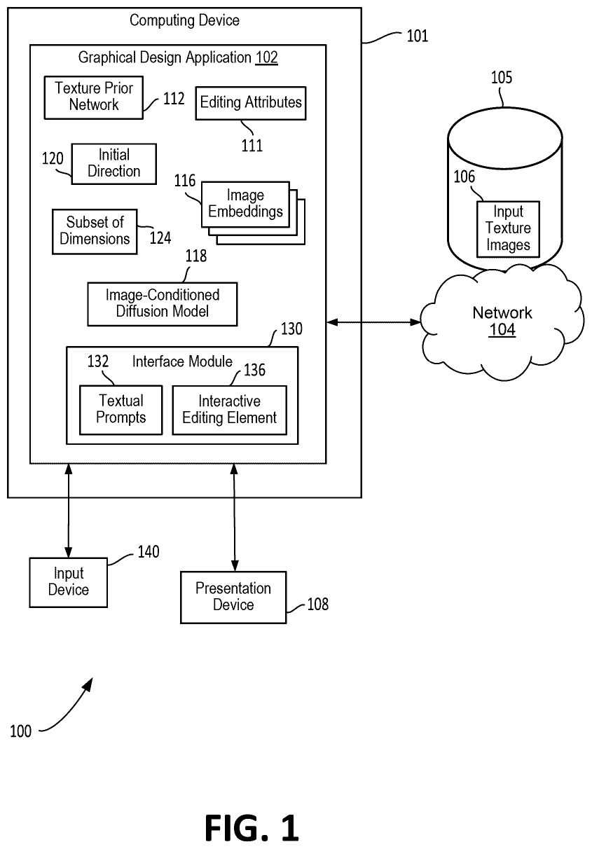

FIG. 1 is a diagram showing an example of a computing environment 100 that provides interactive diffusion-based texture editing, according to certain embodiments. The computing environment 100 includes a computing device 101 that executes a graphical design application 102, a presentation device 108 that is controlled based on the graphical design application 102, and an input device 140 that receives input. Such input may include textual prompts used to define one or more editing attributes and the direction of such attributes. Such a graphical design application may also provide functions including painting, designing, and material transfer as applied to objects to be rendered.

The computing device 101 can be communicatively coupled to other computing devices (not shown) using network 104. Other computing devices may include virtual or physical servers where files may be stored, or where updates to the graphical design application may be stored and distributed to computing device 101. In this example, a storage device 105 is connected to network 104. The storage device may also include photographs or graphical images of input texture images 106, which can be provided to graphical design application 102 and may be displayed to a user on presentation device 108. Such a texture image can be used as input, with textual prompts providing a starting point and an ending point for directional sliders that can be applied to adjust one or more editing attributes 111 of the texture image. The graphical design application 102 includes a stored a texture prior network 112, and an image-conditioned diffusion model 118.

Graphical design application 102 in this example also includes intermediate data structures used in the process of interactive, diffusion-based texture editing. For example, graphical design application 102 includes an initial direction 120 between clusters of image embeddings 116. Graphical design application 102 also includes a subset of dimensions 124 that are derived from the initial direction between the clusters of the image embeddings 116.

In the example of FIG. 1, graphical design application 102 also includes an interface module 130. In some embodiments, the interface module accepts input of textual prompts 132 through input device 140 in order to establish one or more editing parameters, for example, the aging or roughness of a surface, the size of a certain surface feature, etc. In some embodiments, graphical design application 102 can produce images of textures, including the input texture image 106, as well as an interactive editing element 136, which may be, as examples, a slider, a knob, or a list of menu items indicating how much an editable parameter should be changed to achieve the desired texture. The texture images and the editing control element as well as any other displayed elements or texture images can be displayed on presentation device 108. In some embodiments, the graphical design application 102 uses the input device 140, for example, a keyboard, mouse, or trackpad, to select and/or receive input regarding not only the textual prompts, but also for zooming into or out of a view, loading and closing files of texture images, etc.

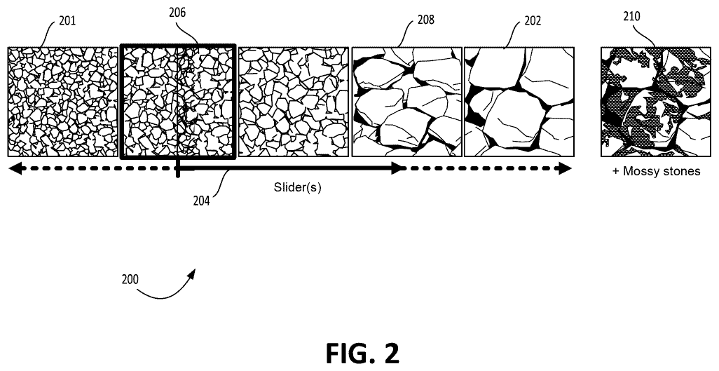

FIG. 2 is a diagram of an example 200 of an interactive texture editing element for interactively changing a texture image, according to certain embodiments. A diffusion-based method of texture editing is provided given an input texture image and a pair of natural language prompts describing an arbitrary edit (e.g., “small stones” to “big stones”). The editing direction is the direction from the texture image relative to the editing attribute from an image 201 corresponding to the first textual prompt to the image 202 corresponding to the second textural prompt. The editing element includes a control such as slider 204, which can be displayed and manipulated to achieve the desired result relative to the editing attribute, in this example, the size of the stones in the stone texture. For example, if the size in image 206 is currently selected, as indicated by the box around the image, a user can move the slider to select the size in image 208, or move it back again. The images can change and provide feedback such that the user can change the editing attribute in real time.

As will be described in further detail below, in the example of FIG. 2, the editing direction is determined in VLM space. A slider can be defined to allow a user to manipulate the texture image along the designated direction (positive and negative) while preserving the texture's original identity. Moreover, the disclosed technique allows multiple edited attributes to be combined in multiple editing directions. The rightmost image 210 in example 200 shows “mossiness” as an additional edited attribute, allowing (“small stones” to be texture edited to “big, mossy stones”).

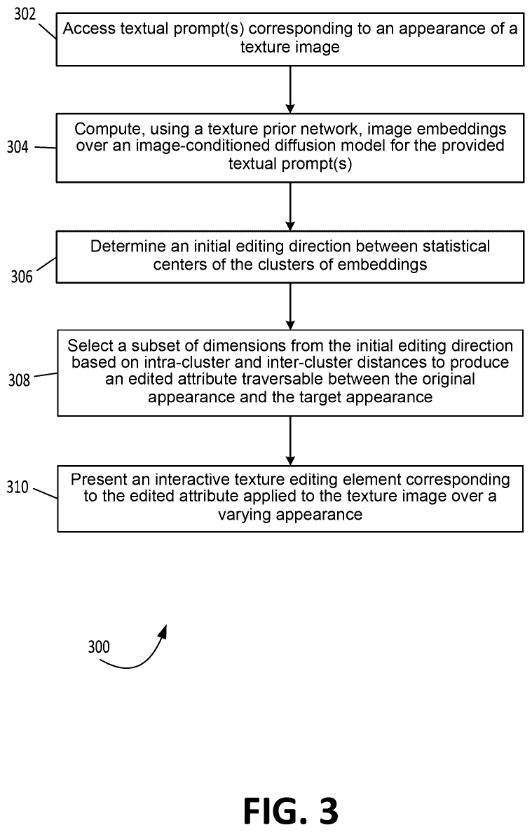

FIG. 3 is a flowchart of an example of a process 300 for interactive diffusion-based texture editing, according to some embodiments. In this example, a computing device carries out the process by executing suitable program code, for example, computer program code executable to provide the interactive texture editing function, such as graphical design application 102. At block 302, the computing device running the graphical design application accesses one or more textual prompts corresponding to the appearance of a texture image. These prompts may have been input to the computing device by a user, for example, using input device 140, which may provide textual prompts 132 through user interface module 130. At block 304, the computing device computes, using a texture prior network, image embeddings over an image-conditioned diffusion model for each textual prompt of the provided textual prompts. This computation produces clusters of embeddings, in this example, one for each of two textual prompts.

Staying with FIG. 3, at block 306, the computing device determines an initial direction between statistical centers of the clusters of embeddings. At block 308, the computing device selects a subset of dimensions from the initial editing direction based on intra-cluster and inter-cluster distances to produce an edited attribute traversable between the original appearance and the target appearance. At block 310, the computing presents an interactive texture editing element corresponding to the edited attribute applied to the texture image over a varying appearance. This edited attribute can change the appearance of the texture image between an original appearance and a target appearance as defined by the supplied textual prompts. For example, with reference to FIG. 2, image 201 corresponds to an original appearance and image 202 corresponds to the target appearance. By “target appearance,” what is meant is the appearance at the extreme end of the editing direction that represents the most change from the original appearance, not necessarily the texture appearance chosen by any given user for any given texture editing project.

The above-described process controls the editing process using sliders with semantic meaning to the typical graphical designer, and that meaning can be defined with straightforward text prompts. While the editing directions could thus be defined in text embedding space, the notion of texture identity is more easily preserved in an image embedding space. Intuitively, it is easier to define the appearance of a texture image when a user also has access to images than by only using textual descriptions, since these typically cannot describe all details that constitute the texture's identity.

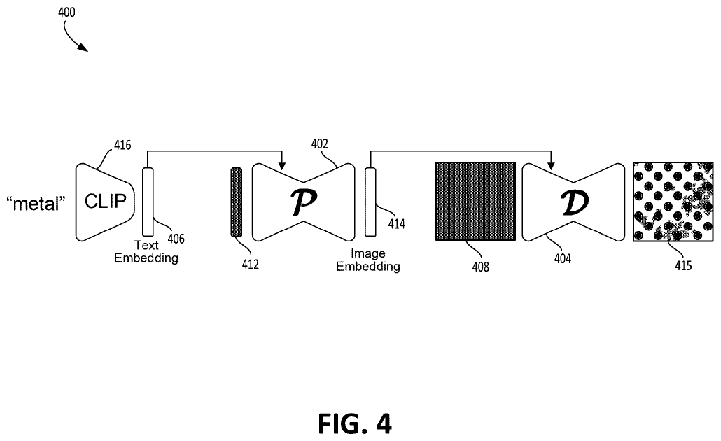

FIG. 4 is an example representation 400 of converting text embeddings to image embeddings as part of providing interactive diffusion-based texture editing, according to certain embodiments. This approach leverages a texture prior network such as domain diffusion prior model 402 ( [symbol] ) to convert text embeddings to image embeddings, enabling the use of the image-conditioned diffusion model 404 (D). Image-conditioned diffusion model 404 is pretrained. The domain diffusion prior model 402 is a diffusion model trained to generate contrastive language-image pretraining (CLIP) image embeddings matching a given CLIP text embedding 406, which is generated by CLIP model 416. A CLIP image embedding is one example of a VLM embedding. This is a generative process, as there are generally multiple image embeddings matching a text embedding.

Continuing with FIG. 4, image-conditioned diffusion model 404 is trained for the texture domain with a dataset of images 408. The domain diffusion prior model 402 is trained separately on a subset 412 of dataset 408, wherein the images in the subset 412 have been classified as textures. The domain diffusion prior model can then produce image embeddings 414. The image-conditioned diffusion model 404 allows the use of text prompts to interact with a network trained on image embeddings, while retaining high image quality and prompt alignment. Thus, a textual input of “metal” for CLIP model 416 can produce a desired metal texture 415.

The approach described herein does not employ cross-attention maps; instead, it relies on finding a direction in CLIP embedding space that preserves identity. Some existing graphical editing techniques depend on cross-attention maps, which are spatial attention maps computed for the text prompts. Cross-attention maps can work for non-texture images that typically have a clear structure with individual objects that correspond to phrases of the text prompt. However, since textures often lack such a clear separation into individual objects, cross-attention maps may be unable to capture any structure to map to the textual prompt and may fail to properly represent texture identity.

The approach described herein treats textures as a specific subdomain within the larger distribution of images that includes images typically learned by diffusion models. The use of a diffusion prior model trained on textures helps preserve identity and constrains the image generation to textures.

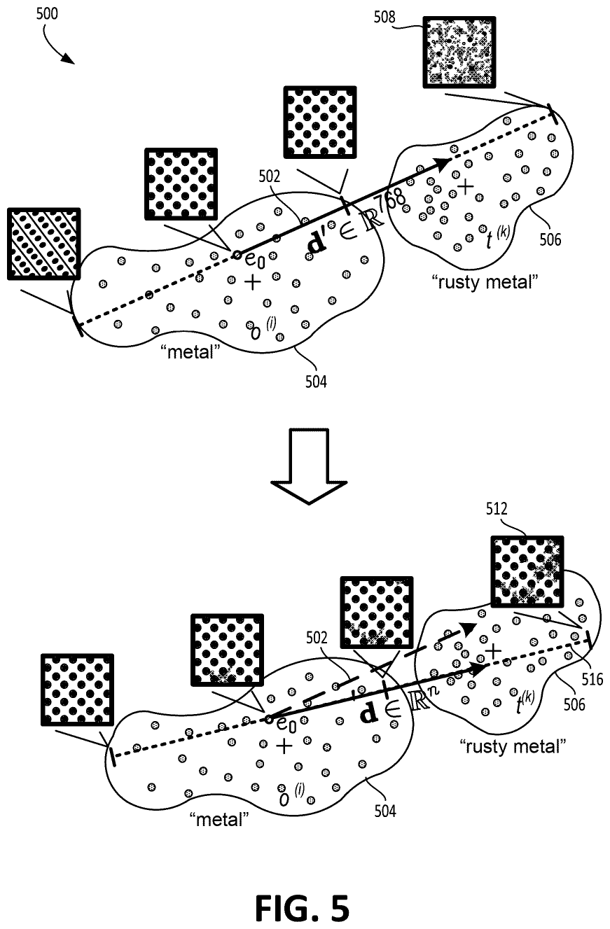

FIG. 5 is an example graphical representation 500 of computing a direction between prompts that define an edited attribute as part of providing interactive diffusion-based texture editing, according to certain embodiments. To perform the desired edits, the system first computes direction 502, d′ϵ [symbol] ⁷⁶⁸, as the difference between the centroids of the cluster 504 and cluster 506 formed by the image embeddings of the two textual prompts that define the edited attribute, in this example, “metal” to “rusty metal.” Naively applying this direction to a specific texture e₀ leads to significant identity variations as an edit marches along such direction towards rusty metal 508. Instead, the system selects a subset of n relevant dimensions (n<768) that do contribute to the desired edit, leading to our final editing direction 516 (d), which preserves the identity of the input texture in the edit that corresponds to the second textural prompt, yielding rusty metal 512. In FIG. 5, the high-dimensional CLIP image embedding space is represented in two dimensions for visualization purposes. The number 768 is selected above because in testing an application, it has been determined that for many textures, using more than 768 dimensions results in some of the original appearance of the texture image being lost to a degree that some graphics designers would find unacceptable. The appropriate number may vary depending on a specific application and software engineers or authors can determine what dimensional limit is appropriate for a specific application. An application can also be designed so that this limit can be set through a configuration menu to the liking of a particular user of the application.

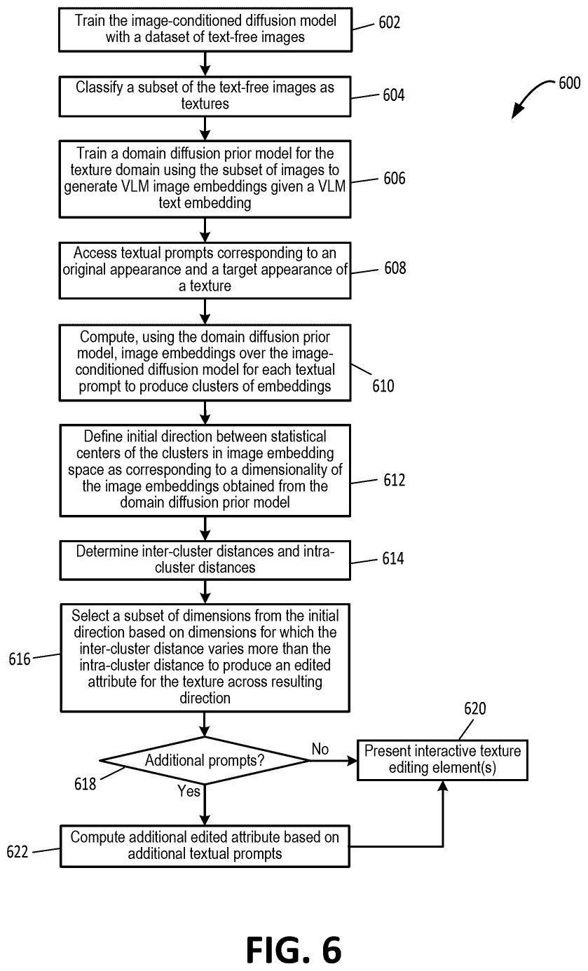

FIG. 6 is a flowchart of another example of a process 600 for providing interactive diffusion-based texture editing, according to certain embodiments. In this example, a computing device carries out the process by executing suitable program code, for example, computer program code for an application such as graphical design application 102. At block 602, the computing device running the graphical design application, or perhaps a computing device that is a server to distribute updates or new versions of the graphical design application, trains the image-conditioned diffusion model with a dataset of text-free images. In one example, the image-conditioned diffusion model is trained with 77 million images with no humans or text. This creates a pretrained model that can be used over time. Training does not need to be completed each time the model is used. At block 604, a computing device classifies a subset of the text-free images as textures.

At block 606 of FIG. 6, a computing device trains a texture prior network, in this example a domain diffusion prior model, for the texture domain using the subset of images. This pretraining enables the domain diffusion prior model to generate CLIP image embeddings given a CLIP text embedding. In one example, the domain diffusion prior model is trained to generate image embeddings in the texture part of the CLIP L/14 embedding space using a ten million image subset of the 77 million images used to train the image-conditioned diffusion model, encouraging the generation of texture like images. As with the image-conditioned diffusion model, this training creates a pretrained prior model that can be used over time. Training does not need to be completed each time the model is used. The prior allows the use of text prompts to interact with a network trained on image embeddings, while training for high generation quality and prompt alignment. These models provide for the use of a latent diffusion model (the image-conditioned diffusion model) alongside a domain diffusion prior trained for the texture domain.

Continuing with FIG. 6, at block 608, the computing device accesses textual prompts corresponding to an original appearance and a target appearance of a texture image. These prompts may be accessed by retrieving them as input through an interface module such as interface module 130, or by accessing prompts stored in memory. At block 610, the computing device running an application such as graphical design application 102 computes, using the domain diffusion prior model, image embeddings over the image-conditioned diffusion model for each textual prompt to produce clusters of embeddings. At block 612, the computing device defines the initial direction between statistical centers of the clusters in image embedding space as corresponding to a dimensionality of the image embeddings obtained from the domain diffusion prior model. The goal is to define a direction d in image embedding space, specified by a pair of understandable text prompts that describe the original and target appearance (e.g., from “metal” to “rusty metal”), where the direction will act as a slider that can be expressed as an interactive display element: marching along such a direction (positive and negative) to progressively increase or decrease the intensity of the desired parameter edit.

To define an initial direction, the CLIP text embeddings of the original and target prompts are computed and fed to the prior [symbol] , yielding image embeddings within the texture domain that fit the textual descriptions. In order to obtain a robust representation of the editing prompts, a set of nₑ image embeddings are computed for the original and target prompts by sampling the prior. These image embeddings can be termed o⁽ⁱ⁾ and t^{(k)}, respectively, with both i and kϵ{1 nₑ}. The number nₑ of image embeddings is an adjustable parameter that can be set to, for example, 150 for both the original and target embeddings. An initial editing direction d′ in image embedding space can then be defined as the difference between the centroids of the clusters formed by the original and target embeddings. Note that d′ϵ [symbol] ⁷⁶⁸, as it corresponds to the dimensionality of the image embedding obtained from the diffusion prior model. Each component d′ can be given by:

$${d}_{j}^{′} = \frac{1}{{n}_{e}} ( {\sum }_{k} {t}_{j}^{( k )} - {\sum }_{i} {o}_{j}^{( i )} ) . \qquad ( 1 )$$

Computing multiple image embeddings to obtain this initial direction aids in disentangling the relevant attribute(s) from the rest but may not suffice because it can lead to poor results in terms of preserving the fundamental identity of the input texture. To better preserve the identity of the input texture while progressively changing the desired attribute, a subset of relevant dimensions can be selected, avoiding those that do not contribute to the desired edit, or lead to unacceptable identity variations. At block 614 of FIG. 6, the computing device determines inter-cluster distances and intra-cluster distances. At block 616, the computing device selects a subset of dimensions from the initial direction. The functions included in blocks 610-616 and discussed with respect to FIG. 6 can be used in implementing a step for defining, using an image-conditioned diffusion model, a varying appearance of the texture image, the varying appearance corresponding to the textual prompt.

The relevant dimensions as given by the standard deviation std, compared to their inter-cluster variability, as given by the distance between cluster centroids can be used. Dimensions with high inter-cluster variability may contribute more to the desired edit, while dimensions with high intra-cluster variability may encode the identity of each individual texture within each cluster. The computing device can therefore select those dimensions whose inter-cluster distance varies more than that of the intra-cluster distance, as those dimensions are more likely to be representative of the edited attribute. The remaining dimensions can be set to zero. The components of the resulting direction vector d (516 in FIG. 5) are thus:

$${d}_{j} = \{ \begin{matrix}{d}_{j}^{′} , & if \vert {d}_{j}^{′} \vert > τ \cdot \begin{matrix}std \\ k\end{matrix} ( {\tilde{t}}_{j}^{( k )} ) and \vert {\tilde{d}}_{j}^{′} \vert > τ \cdot \begin{matrix}std \\ j\end{matrix} ( {\tilde{o}}_{j}^{( i )} ) \\ 0 , & otherwise .\end{matrix} \qquad ( 2 )$$

The relationship is modulated by a threshold τ (for example, 0.8), and applied over normalized vectors

$${\tilde{d}}_{j}^{′} ,$$

\hat{τ} and õ, so that the comparison is meaningful. Given d, the edited attribute can march along the resulting direction to obtain different degrees of the desired edit, for instance by using a slider. Given the image embedding e₀ of a texture image to be edited, the final image embedding e_{α} becomes:

$${e}_{α} = {e}_{0} + α \cdot d , \qquad ( 3 )$$

where α modulates the intensity of the edit, and can take positive or negative values. The resulting e_{α} can then used as conditioning in diffusion model [symbol] to generate the final, edited texture image.

Staying with FIG. 6, at block 618 a determination is made as to whether there are additional prompts that might be used to apply an additional edited attribute to the texture image. For example, the “mossiness” edited attribute shown in FIG. 2 is an additional edited attribute for the stones pictured there. Besides using precomputed sliders for editing, a user can create new ones adapted to the user's needs by providing two text prompts again. If there are no additional prompts, the interactive texture editing element, for example, images with a slider, is presented at block 620. If there are additional prompts at block 618, one or more additional edited attributes are determined at block 622 based on the additional textual prompts. The interactive texture editing elements are presented at block 620. Defining a new texture control can take mere minutes using a single GPU, resulting in faster and more efficient editing than possible with prior techniques.

Since CLIP image embeddings can be a faithful representation of a texture's appearance, CLIP embedding of any input image can be used as conditioning to reconstruct the texture. From this embedding and a pair of prompts, the technique described herein can be used to compute the editing direction and generate textures with different degrees of edits. Test results using real photographs resulted in successful edits for different material types and attributes, such as wetness and smoothness. In some circumstances, the accuracy of the reconstruction can be improved by inverting the image-conditioned diffusion model.

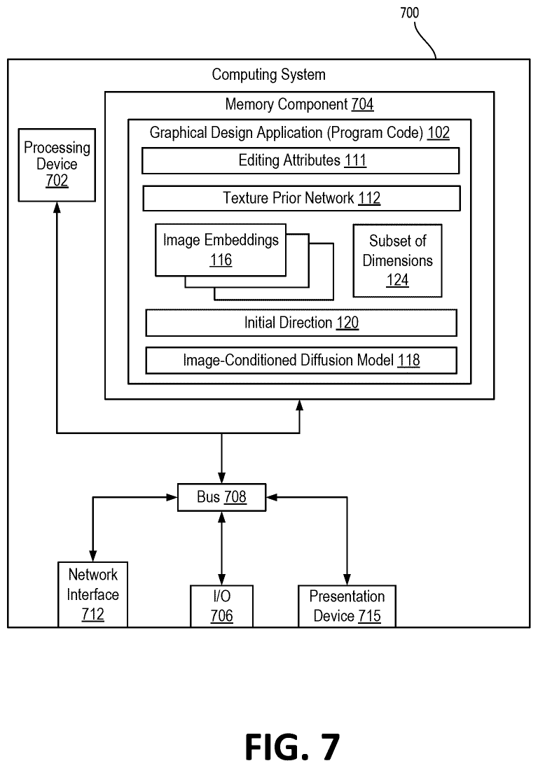

FIG. 7 depicts a computing system 700 that executes the graphical design application 102 with the capability to provide interactive diffusion-based texture editing, according to some embodiments. System 700 includes a processing device 702 communicatively coupled to one or more memory components 704. The processing device 702 executes computer-executable program code stored in the memory component 704. Examples of the processing device 702 include a processor, a microprocessor, an application-specific integrated circuit (“ASIC”), a field-programmable gate array (“FPGA”), or any other suitable processing device. The processing device 702 can include any number of processing devices, including a single processing device. The memory component 704 includes any suitable non-transitory computer-readable medium for storing data, program code, or both. A computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read executable instructions. The executable instructions may include processor-specific instructions generated by a compiler or an interpreter from code written in any suitable computer-programming language, including, for example, C, C++, C#, Visual Basic, Java, Python, Perl, and JavaScript.

Still referring to FIG. 7, the computing system 700 may also include a number of external or internal devices, for example, input or output devices. For example, the computing system 700 is shown with one or more input/output (“I/O”) interfaces 706. An I/O interface 706 can receive input from input devices and provide output to output devices (not shown) for example, to render texture images and texture editing display elements such as sliders or knobs. One or more buses 708 are also included in the computing system 700. The bus 708 communicatively couples one or more components of a respective one of the computing system 700.

The processing device 702 executes program code (executable instructions) that configures the computing system 700 to perform one or more of the operations described herein. The program code includes, for example, graphical design application 102 or other suitable applications that perform one or more operations described herein and/or to cause the processing device 702 to perform the operations. The program code may be resident in the memory component 704 or any suitable computer-readable medium and may be executed by the processing device 702 or any other suitable processing device. Memory component 704, at least during operation of the computing system, includes executable portions of the graphical design application or stored data structures for use by the graphical design application, for example, editing attributes 111, image-conditioned diffusion model 118, image embeddings 116, texture prior network 112, and/or interface module 130. Processing device 702 can access portions as needed. Memory component 704 is also used to store the initial editing direction 120 and the subset of dimensions 124 for defining the editing element, as well as other information or data structures, shown or not shown in FIG. 7.

The system 700 of FIG. 7 also includes a network interface device 712. The network interface device 712 includes any device or group of devices suitable for establishing a wired or wireless data connection to one or more data networks. Non-limiting examples of the network interface device 712 include an Ethernet network adapter, a wireless network adapter, and/or the like. The system 700 is able to communicate with one or more other computing devices (e.g., another computing device executing other software, not shown) via a data network (not shown) using the network interface device 712. Network interface device 712 can also be used to communicate with network or cloud storage used as a repository for images of input textures that can be input to the graphical design application 102. Such network or cloud storage can also include updated or archived versions of the graphical design application for distribution and installation.

Staying with FIG. 7, in some embodiments, the computing system 700 is also communicatively coupled to the presentation device 715 depicted in FIG. 7. A presentation device 715 can include any device or group of devices suitable for providing visual, auditory, or other suitable sensory output. In examples, presentation device 715 displays input and edited textures, as well as display elements that provide a slider to move between various levels of application of an edited attribute defined by the textual prompts. Non-limiting examples of the presentation device 715 include a touchscreen, a monitor, a separate mobile computing device, etc. In some aspects, the presentation device 715 can include a remote client-computing device that communicates with the computing system 700 using one or more data networks. System 700 may be implemented as a unitary computing device, for example, a notebook or mobile computer. Alternatively, as an example, the various devices included in system 700 may be distributed and interconnected by interfaces or a network with a central or main computing device including one or more processors.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “accessing,” “generating,” “processing,” “computing,” and “determining” or the like refer to actions or processes of a computing device, such as one or more computers or a similar electronic computing device or devices that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computing system from a general-purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device. The methods described herein can also be implemented in a web browser.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “configured to” or “based on” herein is meant as open and inclusive language that does not foreclose devices adapted to or configured to perform additional tasks or steps. Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times. Headings, lists, and numbering included herein are for ease of explanation only and are not meant to be limiting. The term “selectively” as applied to an operation that is part of a process refers to the operation being performed or not depending on a precondition, state, or circumstance.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation and does not preclude inclusion of such modifications, variations, and/or additions to the present subject matter as would be readily apparent to one of ordinary skill in the art.

What is claimed is:

1. A method comprising:
accessing a texture image and a textual prompt corresponding to the texture image;
computing, using an image-conditioned diffusion model, image embeddings corresponding to the textual prompt;
defining, using the image embeddings, a varying appearance of the texture image, the varying appearance corresponding to the textual prompt; and
presenting the varying appearance of the texture image for display in an interactive texture editing element.

2. The method of claim 1, wherein defining the varying appearance of the texture image further comprises defining an initial editing direction in image embedding space as corresponding to a dimensionality of the image embeddings.

3. The method of claim 2, further comprising selecting a subset of dimensions from the initial editing direction based on an intra-cluster distance and an inter-cluster distance for the image embeddings.

4. The method of claim 1, wherein the textual prompt comprises a first textual prompt corresponding to an original appearance of the texture image and a second textual prompt corresponding to a target appearance of the texture image.

5. The method of claim 1, further comprising:
accessing an additional textual prompt;
computing additional image embeddings based on the additional textual prompt; and
defining, using the additional image embeddings, an additional varying appearance of the texture image; and
presenting the additional varying appearance of the texture image for display in the interactive texture editing element.

6. The method of claim 1, further comprising using a texture prior network including a domain diffusion prior model to apply the image embeddings to the image-conditioned diffusion model.

7. The method of claim 6, wherein the domain diffusion prior model is trained using text-free images to generate visual language model (VLM) image embeddings given a VLM text embedding.

8. A system comprising:
a memory component including an image-conditioned diffusion model; and
a processing device coupled to the memory component to perform operations comprising:
accessing a texture image and a textual prompt corresponding to the texture image;
computing, using the image-conditioned diffusion model, image embeddings corresponding to the textual prompt;
defining, using the image embeddings, a varying appearance of the texture image, the varying appearance corresponding to the textual prompt; and
presenting the varying appearance of the texture image for display in an interactive texture editing element.

9. The system of claim 8, wherein the operation of defining the varying appearance of the texture image further comprises defining an initial editing direction in image embedding space as corresponding to a dimensionality of the image embeddings.

10. The system of claim 9, wherein the operations further comprise selecting a subset of dimensions from the initial editing direction based on an intra-cluster distance and an inter-cluster distance for the image embeddings.

11. The system of claim 8, wherein the textual prompt comprises a first textual prompt corresponding to an original appearance of the texture image and a second textual prompt corresponding to a target appearance of the texture image.

12. The system of claim 8, wherein the operations further comprise:
accessing an additional textual prompt;
computing additional image embeddings based on the additional textual prompt; and
defining, using the additional image embeddings, an additional varying appearance of the texture image; and
presenting the additional varying appearance of the texture image for display in the interactive texture editing element.

13. The system of claim 8, wherein the operations further comprise using a texture prior network including a domain diffusion prior model to apply the image embeddings to the image-conditioned diffusion model.

14. The system of claim 13, wherein the domain diffusion prior model is trained using text-free images to generate visual language model (VLM) image embeddings given a VLM text embedding.

15. A non-transitory computer-readable medium storing executable instructions, which when executed by a processing device, cause the processing device to perform operations comprising:
accessing a texture image and a textual prompt corresponding to the texture image;
a step for defining, using an image-conditioned diffusion model, a varying appearance of the texture image, the varying appearance corresponding to the textual prompt; and
presenting the varying appearance of the texture image for display in an interactive texture editing element.

16. The non-transitory computer-readable medium of claim 15, wherein the textual prompt comprises a first textual prompt corresponding to an original appearance of the texture image and a second textual prompt corresponding to a target appearance of the texture image.

17. The non-transitory computer-readable medium of claim 15, wherein the instructions further cause the processing device to perform operations comprising:
accessing an additional textual prompt;
defining an additional varying appearance of the texture image; and
presenting the additional varying appearance of the texture image for display in the interactive texture editing element.

18. The non-transitory computer-readable medium of claim 15, wherein the instructions further cause the processing device to perform an operation comprising using a texture prior network including a domain diffusion prior model to apply image embeddings to the image-conditioned diffusion model.

19. The non-transitory computer-readable medium of claim 18, wherein image-conditioned diffusion model and the domain diffusion prior model are trained using text-free images.

20. The non-transitory computer-readable medium of claim 18, wherein the domain diffusion prior model is configured to generate visual language model (VLM) image embeddings given a VLM text embedding.
